(19) United States
(12) Patent Application Publication
(10) Pub. No.: US 2002/0077959 A1
(43) Pub. Date: Jun. 20, 2002

(54) Method and system for using line item bid limits in electonic auctions

(76) Inventors: Marc Alaia, Monroeville, PA (US); David J. Becker, Sewickley, PA (US); Anthony F. Bernard, Wexford, PA (US); Daniel C. Heckmann, Pittsburgh, PA (US); Sam E. Kinney JR., Clyde Hill, WA (US); Glen T. Meakem, Sewickley, PA (US); Vincent F. Rago, Occidental, CA (US); Jason Reneau, Boston, MA (US); Frederick W. Roberts, Pittsburgh, PA (US); William D. Rupp, Mt. Lebanon, PA (US); Robert G. Stevens, Pittsburgh, PA (US)

Correspondence Address: Lesley L. Coulson, MORGAN, LEWIS & BOCKIUS LLP, 1701 Market Street, Philadelphia, PA, 19103-2921, US

(21) Appl. No.: 09/850,676

(22) Filed: May 7, 2001

Related U.S. Application Data
(63) Continuation-in-part of application No. 09/252,790, filed on Feb. 19, 1999.

(51) Int. Cl. G06F 17/60

(52) U.S. Cl. 705/37

(57) ABSTRACT

A method and system for conducting electronic auctions is described. Lots in the auction are comprised of line items. Line item guidelines determine how adjustments are made to line item bid values when the value of the lot bid is adjusted. The value of a line item bid cannot be adjusted to exceed the line item bid maximum, or go below the line item bid minimum.

### REFERENCE TO RELATED APPLICATIONS

This application is a continuation-in-part of copending U.S. application Ser. No. 09/252,790, entitled “Method and System for Controlling Closing Times of Electronic Auctions Involving Multiple Lots”, filed Feb. 19, 1999, previously assigned to the assignee of the present Application, FreeMarkets, Inc. The entirety of the earlier filed co-pending patent application is hereby expressly incorporated herein by reference.

### FIELD OF THE INVENTION

The disclosed inventions relate generally to conducting electronic auctions, and in particular to using flexible line-item guidelines in a business-to-business auction.

### DESCRIPTION OF BACKGROUND

Procurement of goods and services has traditionally involved high transaction costs, especially information search costs. The advent of electronic commerce has introduced new methods of procurement that lower some of the transaction costs associated with procurement. Electronic procurement, in particular business-to-business electronic commerce, matches buyers and suppliers and facilitates transactions that take place on networked processors.

Four models of online procurement have been developed: catalog, buyer-bidding auctions, seller-bidding auctions and exchange marketplaces.

The “catalog” model was an early form of online electronic procurement. Initially, electronic catalogs were developed primarily by sellers, typically suppliers, to help customers obtain information about products, and order supplies electronically. These first electronic catalogs were single-source; i.e. they only allowed customers to obtain information and products from that supplier.

Although these first electronic catalogs greatly reduced the information search costs associated with procurement, customers were disadvantageously “locked in” to one supplier at each electronic catalog. Customers were thus unable to compare a number of competing products in a single catalog. Therefore, certain suppliers with single-source catalogs began including competitors' products in their systems. The inclusion of competing products in electronic catalogs reduced procurement information search costs even further. By offering competing products, electronic catalogs became “electronic markets”.

Many of these catalogs, however, are biased toward the supplier offering the electronic catalog, and it was thought that procurement costs could be lowered further through an unbiased market. Therefore, third-party “market makers” developed markets for many standard products and services, which were intended to be unbiased markets. By having a market maker develop a market for certain products by offering an unbiased electronic catalog, procurement costs are further lowered by promoting competition between suppliers as well as reducing information search costs for buyers.

Electronic commerce using the electronic catalog model typically involves one buyer and one seller at a time. When many buyers compete for the right to buy from one seller, a buyer-bidding auction model, or forward auction is created.

In a forward auction, various goods or services may be simultaneously placed for auction. As in an offline auction, bid prices start low and move upward as bidders interact to establish a closing price. Typically, the auction marketplace is one-sided, with one seller and many potential buyers, although multiple-seller auctions are possible.

Catalog and buyer-bidding auction models, however, have limitations and do not work in every situation. For example, it is difficult for a supplier to publish set prices in a catalog for custom products. Therefore, when a buyer requires a custom or hard-to-find product, pricing for that product typically will not be found in a catalog. Likewise, it is difficult to specify a custom product and identify buyers who might use that custom product for a buyer-bidding auction. Additionally, there may be only one buyer interested in a custom product, such that a buyer-bidding auction may not be applicable in all cases. Thus, there are fewer suppliers and no standard product and pricing information available for the buyer of custom industrial products.

Referring again to the cost of traditional procurement, and particularly procurement of custom products and services, when a company required a custom product, a buyer for the company would typically procure the product by searching for potential suppliers and then acquiring price quotes from the potential suppliers for the needed custom product. The search tended to be slow and random, and typically relied heavily on personal relationships. The costs associated with locating vendors, comparing prices, and negotiating a deal were therefore large. The cost of switching suppliers is also very large, such that an incumbent supplier's quoted price was most likely not the lowest price he could offer because the incumbent supplier knew the buyer would face switching costs to use another supplier. As an additional consequence, new suppliers had a difficult time entering the market.

Therefore, supplier-bidding auctions for products and services defined or specified by a buyer have been developed. The assignee of the present application has developed a system in which sellers downwardly bid against one another to achieve the lowest market price in a supplier-bidding auction.

In both forward and reverse auctions, the dynamics of bidding in an auction work to the advantage of the sponsor of the auction. For example, in a forward auction, bidders may bid more than they would have paid otherwise for a product or service during the final “going, going, gone” stage of the auction because of the time pressure and excitement of the auction atmosphere, and the sponsor of the auction, in this case the seller, benefits. Likewise, in a reverse auction, suppliers may bid less than they would have bid on a supply contract outside the auction, and the sponsor, this time the buyer, benefits.

To take full advantage of auction bidding dynamics, an electronic auction should facilitate bid entry. If the process of submitting a bid to the electronic auction is difficult or cumbersome, the bidder may be less likely to make a bid. Additionally, in the final stages of an auction, bids are made very rapidly, and a bidder must be able to enter a competitive bid quickly and easily in order to “beat the clock”.

In supplier-bidding auctions for custom industrial products, the products are typically divided into several “lots.” Suppliers bid to supply the buyer a lot of products. Each lot is typically comprised of many “line items.” In prior systems, bidders may have been required to enter bids at the line item level. However, auctions typically take place at the lot level, where all of the line item quotes are added up to one sum. This dual structure frequently results from the nature of the market. For instance in the industrial products market, price quotations are typically built from many cost elements that are added up to form price quotes for individual items or groups of items. Some cost elements or items within a market may be negotiable and others may be fixed depending on factors specific to each bidder. For example, a fabricator may not have control over the cost of raw materials. The competition for a lot can thus involve many independent and dependent factors.

Bids are placed in real-time and often in rapid successions. This requires bidders to quickly adjust price quotations for an entire lot, even though the lot may be comprised of hundreds of individual items or cost elements. Many prior online auctions only allowed line item price adjustments, making it difficult to fine-tune the mix of bids. A bidder would have to individually adjust line items, while the software calculated new total lot price bids. This frequently became too time-consuming to keep pace with the auctions.

With the time constraints on bidding, bidders wanted the ability to rapidly adjust the lot price without specifically changing individual line items. Therefore, “pro rata” bid adjustment was developed. With pro rata bid adjustment, bidders can change the total lot price quote, and the software apportions pro rata the change across individual line items in the lot. However, a pro rata apportionment may result in individual items being priced at levels that are uneconomic for the bidder.

What is needed is a way for bidders to control the adjustments that are made to line items prices when a lot price is changed. The present invention allows bidders to set decision rules for limiting the adjustments made at the line item level.

### SUMMARY OF THE INVENTION

The problems encountered with the operation of the prior auction system are overcome by the auction system of the invention, which allows for line item decision rules.

The line item decision rules of the present invention permit bidders to set specific price decision rules for aspects of individual line items within a lot. For example, price limits for line items can be established at the initial price quote entered for that item or at a floor or ceiling above or below the initial quote. Different decision rules can be set for different items and rules can be set across some or all of the line items within a lot. Decision rules can be set dynamically during the course of the bidding event by the bidder.

In one embodiment, flexible line-item decision rules enable bidders to lock-in a fixed and variable portion of the price quote prior to the bid. Total bids for a lot can then be adjusted rapidly in response to market activity without changing individual line item quotes to uneconomic levels. In addition, bidders have the comfort of setting floors or ceilings on individual or cost component bids. During the bidding event, fixed components can be reevaluated and unlocked if necessary in response to movements in the market beyond original expectations. This bidding flexibility allows bidders to participate in the auction fully, and increases competition.

In another embodiment, a bid limit is imposed on each line item. The line item bid limit can specify a value which the line item bid value must be less than in the case of a traditional forward auction, or which the line item bid value must be greater than in the case of a reverse auction. When the bid for a lot is adjusted, the adjustment is distributed over the line items in the lot such that if the potential adjustment to any given line item would cause the line item to violate the rule expressed by the line item bid limit, that line item is excluded from the set of line items eligible to be adjusted in order to adjust the lot bid.

In accordance with one form of the present invention applicable to downward auctions, there is provided a method to control line item price in an electronic auction, wherein said method comprises setting a minimum line item price for a line item in a lot; receiving a bid adjustment for the lot price; calculating a corresponding adjustment for the line item price using the lot bid adjustment; determining if adjusting the line item price by the calculated amount will cause the line item price to be lower than the minimum line item price for the line item; and adjusting the line item price in accordance with said determination.

In addition, in accordance with a further aspect applicable to upward auctions, there is provided a method to control line item price in an electronic auction, wherein said method comprises setting a maximum line item price for a line item in a lot; receiving a bid adjustment for the lot price; calculating a corresponding adjustment for the line item price using the lot bid adjustment; determining if adjusting the line item price by the calculated amount will cause the line item price to exceed the maximum line item price for the line item; and adjusting the line item price in accordance with said determination.

Thus, the present invention provides a method and apparatus that beneficially encourages bidders to place bids, thereby improving auction dynamics.

### BRIEF DESCRIPTION OF THE DRAWINGS

FIG. 1 is a schematic illustration of the elements and entities involved in an embodiment of an auction;

FIG. 2 is a schematic illustration of the communications links between the coordinator, the sponsor and the bidders in the Auction of FIG. 1;

FIG. 3 is a schematic illustration of auction software and computers posting that software and an embodiment of an auction; and

FIG. 4 is a flowchart illustrating one embodiment of a line item bid limit rule implementation.

### DETAILED DESCRIPTION

Reference will now be made in detail to the preferred embodiments of the present invention, examples of which are illustrated in the accompanying drawings. It is to be understood that the Figures and the description of the present invention included herein illustrate and describe elements that are of particular relevance to the present invention, while eliminating, for purposes of clarity, other elements found in typical auction systems and computer networks.

Supplier-Bidding Auction

In a supplier-bidding auction, bid prices start high and move downward in reverse-auction format as bidders interact to establish a closing price, The auction marketplace is typically one-sided, i.e. one buyer and many potential suppliers, although multiple-buyer auctions are possible. In a supplier-bidding auction, bidders are potential suppliers bidding for the right to supply the buyer, or sponsor of the auction, with the products or services in the auction.

Typically, the products being purchased are components or materials. “Components” typically mean fabricated tangible pieces or parts that become part of assemblies of durable products. Example components include gears, bearings, appliance shelves or door handles. “Materials” typically mean bulk quantities of raw materials that are further transformed into product. Example materials include corn syrup or sheet steel.

Industrial buyers do not typically purchase one component at a time. Rather, they tend to purchase whole families of similar components. Therefore, in a typical industrial supplier-bidding auction, products are grouped together in “lots” for bidding. Each lot is composed of several “line items”. In the auction, the suppliers are bidding on supplying the buyer with everything in a lot. By lotting products, potential suppliers can bid on only that portion of the business for which they are best suited, and are not required to bid on every lot. This reduces some of the barriers to entry for new potential suppliers that may only have capability to supply some of the needed products in the auction. Reducing the barriers to entry also benefits the buyer as additional bidders increase competition, and result in better bidding dynamics.

Typically, components are strongly related to one another. As an example, a buyer might purchase a given plastic knob in two different colors, or might purchase a nameplate in four different languages. These parts are so similar that by definition they must be purchased from the same supplier—all of the knobs are made using the same mold. These items are therefore grouped into a single lot. As is known to one skilled in the art, there are many additional methods of lotting products for an auction.

Bidding in an auction with lots may be at the lot level or at the line item level. If bidding occurs at the lot level, bidders bid a price for supplying every product or service in a lot. If bidding occurs at the line item level, bidders bid a price for each line item, and these line item bids are aggregated by the auction software into a lot-level bid. In either case, competition occurs at the lot level.

Auction Process

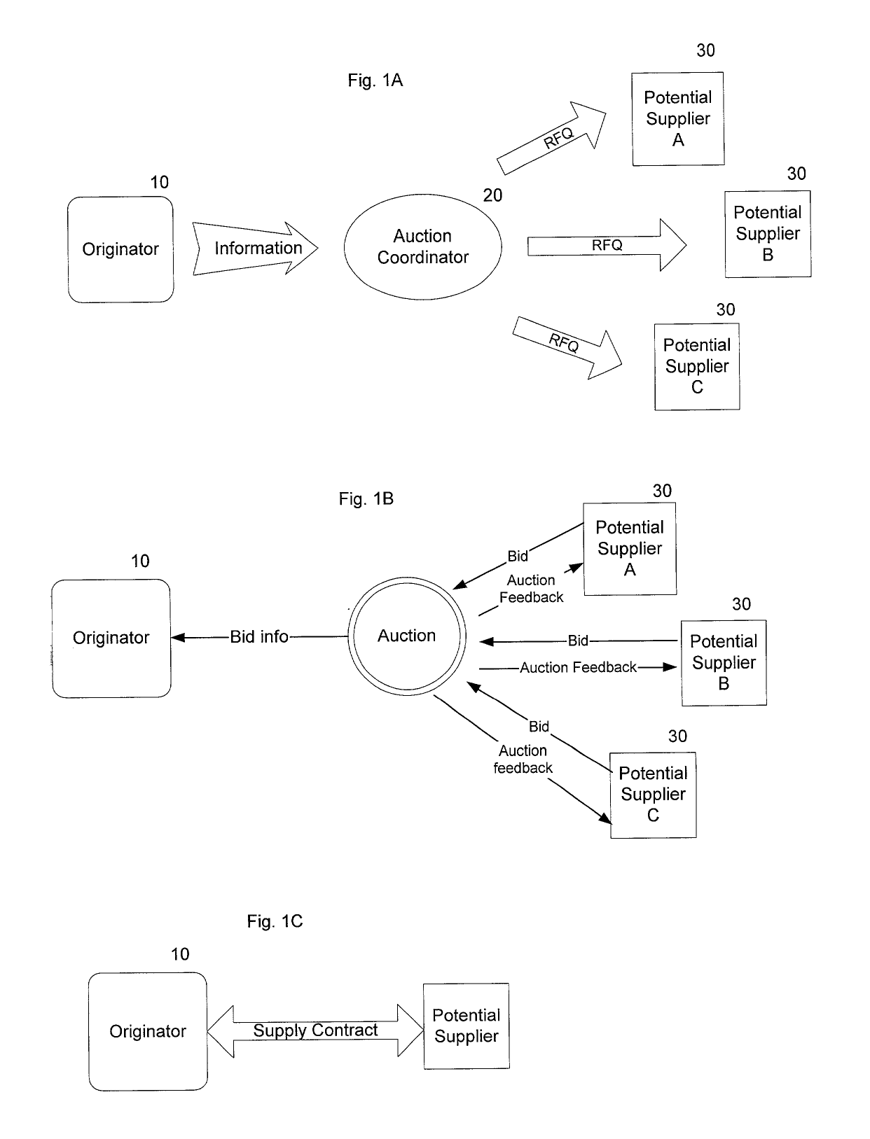

The basic process for a supplier-bidding auction as conducted by the assignee of the present application is described below with reference to FIG. 1. FIG. 1 illustrates the functional elements and entities in a typical supplier-bidding auction. FIG. 1A illustrates the creation of an auctioning event, FIG. 1B illustrates the bidding during an auction, and FIG. 1C illustrates results after completion of a successful auction.

As will be apparent to one skilled in the art, while the invention is generally described in terms of one buyer and multiple sellers, the present invention may also be used in other types of electronic markets, such as auctions with multiple buyers and multiple sellers, forward auctions having a single seller and multiple potential buyers, or electronic exchange marketplaces.

The term “sponsor” will be utilized to identify the party or parties that originate the auction. In a forward auction, for example, the sponsor is typically a seller of one or more goods or services. In a forward auction, the sponsor(s) might specify a good to be sold in the auction and receive bids from parties wishing to purchase that good. Those parties wishing to purchase that good are “bidders” in a forward auction.

In a reverse auction, the sponsor is typically a purchaser or buyer of one or more goods or services. In a reverse auction, the sponsor(s) buyer might specify a good desired for purchase through the auction and receive bids from parties wishing to supply that good. Those parties wishing to supply that good are “bidders” in a reverse auction.

In a supplier-bidding auction model, the bidding product or service is typically defined by the sponsor of the auction. An auction coordinator may work with the sponsor to prepare for and conduct an auction, and to define the potentially new supply relationships resulting from the auction.

As shown in FIG. 1A, when the sponsor 10 decides to use the auction system of the present invention to procure products or services, the sponsor 10 provides information to an auction coordinator 20. This information may include information about incumbent suppliers and historic prices paid for the bidding products or services, for example. Typically, the sponsor 10 works with the auction coordinator 20 to define the bidding products and services, and if desired, lot the products and services appropriately so that the needed products and services can be procured using optimal auction dynamics. A specification may then be prepared for each desired product or service and a Request for Quotation (RFQ) generated for the auction.

Next, the auction coordinator 20 identifies potential suppliers 30, preferably with input from the sponsor 10, and invites the potential suppliers 30 to participate in the upcoming auction. Suppliers that accept Auction invitations may be sent notices regarding the upcoming Auction, as well as client software to install in preparation for participating in the Auction.

The potential suppliers are given access to the RFQ, typically through a printed published RFQ document, although the RFQ may be electronically published on an identified Website, or delivered via a CD, for example. The RFQ includes specifications for all of the parts to be auctioned. As described above, similar part or commodity line items are typically aggregated into job “lots” in the RFQ. The RFQ provides information about the lots, and the line items within the lots.

As shown in FIG. 1B, during a typical auction, bids are made against lots. Generally, bidders must submit actual unit prices for all line items within a lot, however, the competition in an auction is based on the aggregate value bid for lots. The aggregate value bid for a lot depends upon the level and mix of line item bids and the quantity of goods or services that are offered for each line item. Therefore, although bidders may submit bids at the line item level, they are competing on the lot level. During the auction, the sponsor 10 can typically monitor the bidding as it occurs. Bidders 30 may also be given some feedback on the auction activity so that they may bid competitively.

Feedback about bidding activity is generally referred to as “market feedback” and may include any information or data related to the bidders 30 or their bids, interrelationships between bids, and any other bid related information or data that is received before or during the auction. Market feedback may include, for example, bids that have been placed by other bidders, the rank of a bidders' bid in relation to one or more other bidders, the identity of bidders, or any subset of that information. Market feedback may also include non-pricing information such as, for example, the quality of goods to be provided by bidders and shipping costs associated with one or more bidders. Providing such market feedback to bidders in an auction helps create real-time competitive interaction among bidders in the auction because, without feedback, bidders who are not leading in an auction might not be aware of their relative position and have less incentive to revise price quotes and place additional competitive bids.

After the auction, the auction coordinator may analyze the auction results with the sponsor. In a supplier-bidding auction, the sponsor typically conducts final qualification of the low bidding supplier(s). The sponsor may retain the right not to award business to a low bidding supplier based on final qualification or other business concerns. As shown in FIG. 1C, at least one supply contract is usually drawn up and executed based on the results of the auction.

Communications and Software

The auction is conducted electronically between bidders 30 at their respective remote sites and the coordinator 20 at its site. In an alternative embodiment, instead of the auction coordinator 20 managing the auction at its site, the auction sponsor may perform auction coordinator tasks at its site.

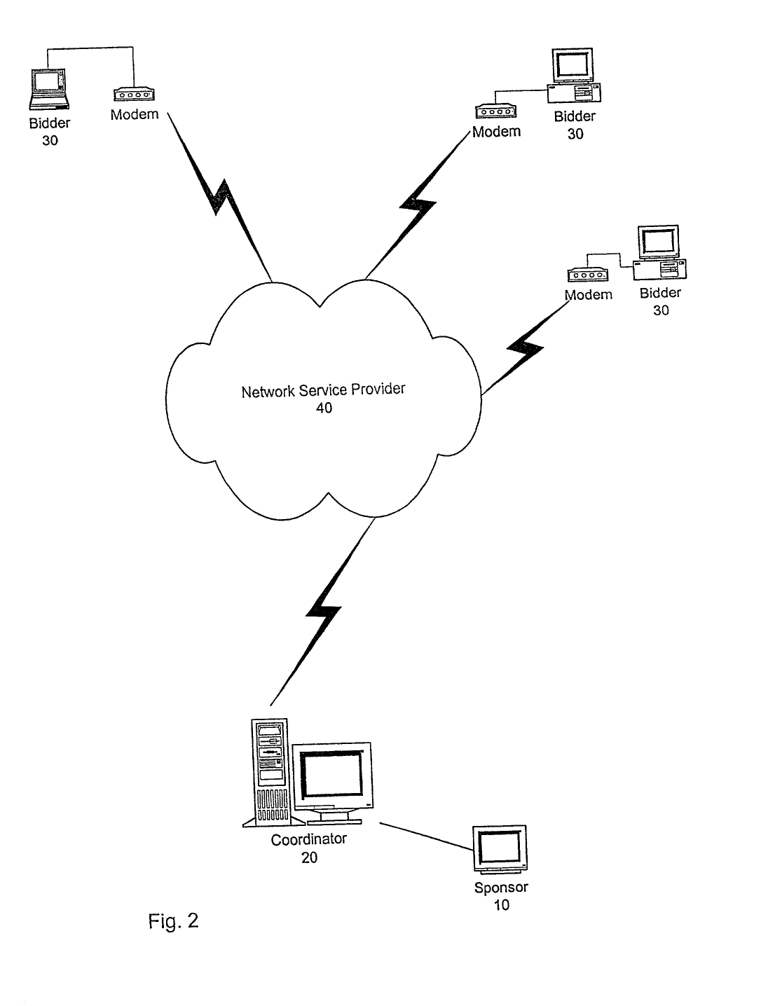

Information is conveyed between the coordinator 20 and the bidders 30 via any known communications medium. As shown in FIG. 2, bidders 30 may be connected to the auction through the Internet via a network service provider accessed, for example, through a dial-up telephone connection. Alternatively, sponsors 10 and bidders 30 may be connected to the auction by communicating directly with the coordinator 20 through a public switched telephone network, a wireless network, or any other known connection method. Other methods of connecting sponsors and bidders and other communications mediums are known to those skilled in the art, and are intended to be included within the scope of the present invention.

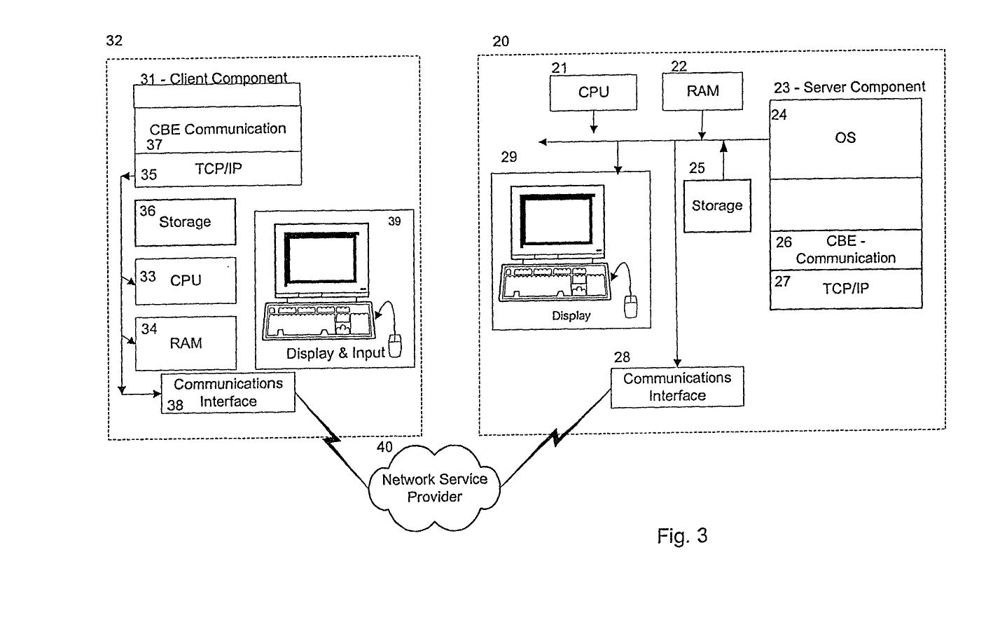

A computer software application is used to manage the auction. The software application may have two components: a client component 31 and a server component 23. FIG. 3 illustrates a server component 23 and a client component 31 resident in host computers in a first embodiment. As is shown in FIG. 3, the server component of this embodiment includes an operating system 24, competitive bidding event communications software 26, and Internet protocol software 27. The server software is hosted on a computer 20 having a processor 21, random access memory 22, and a data storage facility 23. The host computer 20 also includes input and output devices 29 such as, for example, a monitor, printer, mouse and keyboard, and a communications interface 28 for communicating with the client component 31.

The client component of the embodiment illustrated in FIG. 3 includes competitive bidding event communication software 37, and Internet protocol software 35. The client component software is hosted on a computer 32 having a processor 33, random access memory 34, and a data storage facility 36. The host computer 32 also includes input and output devices 39 such as, for example, a monitor, printer, mouse and keyboard, and a communications interface for communicating with the service component 23.

The client component 31 is used by bidders 30 to make bids during the auction, and to receive and display feedback from the auction. The client component may, for example, be a program that is installed on a bidder's computer, or it may be software that is accessed and run from a Website. The client component 31 preferably includes software and a graphical user interface for implementing the line item decision rules of the present invention in connection with FIGS. 5-7 below.

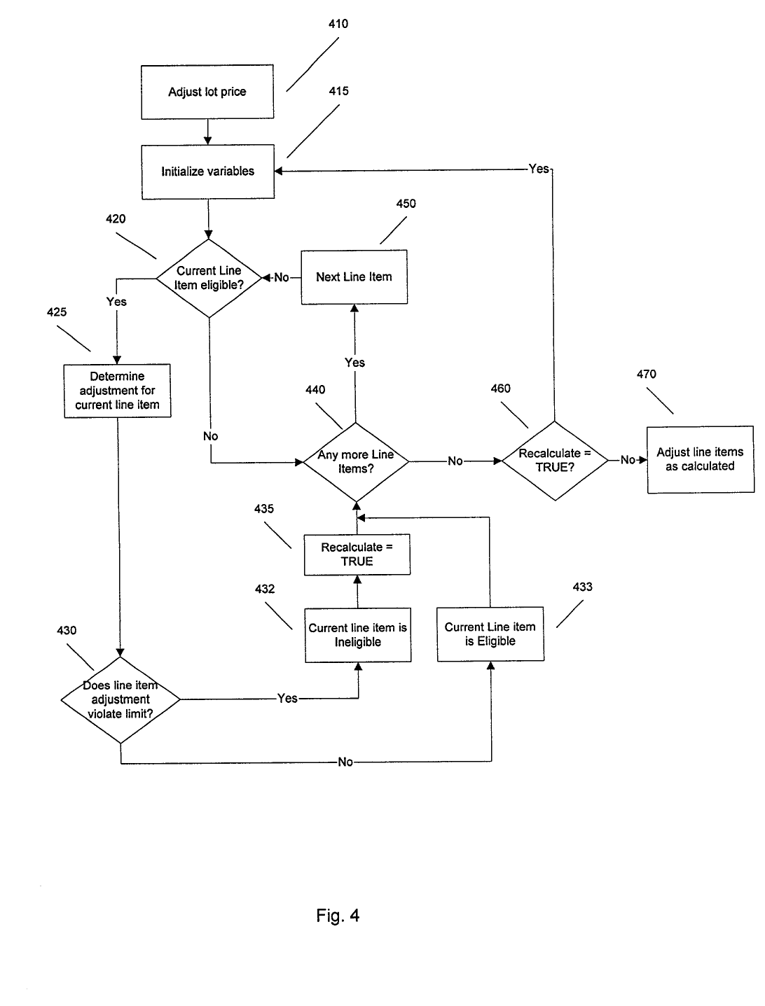

Preferably, bids may only be submitted into the auction through use of the client component of the application, thereby ensuring that buyers cannot circumvent the bidding process, and that only invited bidders participate in the bidding. Each computer software application may be stored in a data storage device and executed by a processor such as those described in connection with FIG. 4 described hereinbelow.

Bids are sent over the communications medium to, for example, the auction coordinator, or where the sponsor is performing auction coordinator tasks, directly to the sponsor. Bids are received by the server component 23. The client component includes software functions for making a connection over the Internet, or other medium, to the server component. Bids are submitted over this connection and feedback may be sent to connected bidders.

Although the present invention is described in terms of a server component and a client component, one skilled in the art will understand that the present invention is not limited to a client/server program relationship model, and may be implemented in a peer-to-peer communications model, or any other model known to those skilled in the art.

When a bidder submits a bid, that bid is sent to the server component and evaluated to determine whether it is a valid or acceptable bid. For example, a bid may be evaluated to determine whether the bid is from an authorized bidder, and whether the bid has exceeded a pre-determined maximum acceptable price. Market feedback about received bids may be sent to connected bidders enabling bidders to see changes in market conditions and plan competitive responses.

The embodiments herein utilize an online reverse auction, wherein the present invention is performed by a computer processor, as an example in which the present invention may be utilized. In these examples, suppliers bid to supply goods or services to a buyer and the buyer typically purchases the goods or services from the lowest priced qualified bidder. It is to be understood, however, that the present invention may be used in other applications. The auction does not necessarily have to occur online, and the present invention may be performed by other than a computer processor. The present invention may also be utilized in connection with auctions other than reverse auctions. For example, the present invention may be advantageously utilized with forward auctions, wherein the bidder offering the highest qualified bid, rather than the lowest, is awarded the goods or services being sold. In the case of a forward auction, the “leading bid” is the highest bid and the leading bidder is the bidder making that highest offer, while in a reverse auction, the “leading” bid is the lowest bid and the leading bidder is the bidder making the lowest bid. Similarly, placing a “better bid” in a reverse auction indicates placing a lower bid, while placing a “better bid” in a forward auction indicates placing a higher bid.

Bidding Dynamics

Bidders prepare their price quotes in light of a number of factors. In a reverse auction for customer industrial parts, these factors may include raw material prices, the design of existing dies or fixtures, the dimensional tolerance required of the component, the amount of engineering support the purchaser desires, the speed with which this particular buyer pays invoices, and the distance the product must be shipped.

Supplier-specific factors may also affect the price quotes. Capacity availability, desirability of this particular buyer as a customer, desired levels of profit, and desire to diversify into other markets can all affect the price the seller is willing to accept to supply the needed product. Market-specific factors that are not predictable during the preparation of quotations but that are evident during the auction can also be important in determining, for example, how aggressively other participants may bid.

In business-to-business auctions that are conducted for important custom components, low bidders may still be “passed over” if other bidders demonstrate non-price advantages.

Sometimes auctions involve parts that the purchaser has procured before, and are possibly currently being made by one or more suppliers. These are termed “existing parts.” When a part is currently being made by a supplier, that supplier is termed the “incumbent supplier.” In an auction situation, the incumbent supplier is placed in a position of having to defend its contract with the purchaser.

Incumbent suppliers are expected to behave differently than outsiders. An incumbent, for example, knows that the buyer's switching costs favor the incumbent even at a price premium to the market. Because the buyer may pass over low bidders, incumbent suppliers can take advantage of their incumbent status.

Certain human factors must also be considered when conducting business-to-business auctions for industrial purchasing. If not considered, these human factors can interfere with achieving desired outcomes. Bidders must be comfortable with the auction software. Bidders often speak English as a second language, or not at all, making it desirable to provide interpreters.

Bidders must often respond to multi-million-dollar decisions in a few seconds. The fast response required creates cognitive limits—a bidder cannot realistically focus on more than one decision at a time. Many bidders are under some sort of emotional stress when participating, due to the change involved. In some cases, incumbent bidders are literally “fighting for their lives” in situations where losing the contract in question literally means losing their business.

As discussed above, the competition in the auction takes place at the lot level, where all of the line item quotes are added up to one sum. Price quotations may be built from many cost elements that are added up to form price quotes for individual items or groups of items. Some cost elements or items within a market may be negotiable and others may be fixed depending on factors specific to each bidder. For example, a fabricator may not have control of raw material costs. The competition for a lot can thus involve many independent and dependent factors.

Bids are placed in real-time and often in rapid successions. This requires bidders to quickly adjust price quotations for an entire lot, even though the lot may be comprised of hundreds of individual items or cost elements. Early online auctions only allowed line item price adjustments, and it was difficult to fine-tune the mix of bids. A bidder would have to individually adjust line items, while the software calculated new total lot price bids. This was frequently too time-consuming to keep pace with the auction.

With the time constraints on bidding, bidders want the ability to be able to rapidly adjust the lot price without the need to specifically change individual line items. Therefore, “pro rata” bid adjustment was developed. With pro rata bid adjustment, bidders could change the total lot price quote, and the software would apportion pro rata the change across individual line items in the lot. However, a pro rata apportionment may result in individual items being priced at levels that are uneconomic for the bidder. For some items the bidders may wish to set decision rules for adjusting the unit price quotes at the line item level. For example, bidders may wish to lock-in a preset floor or ceiling on particular line items within a low. These decision rules, or “locks” cause the pro rata adjustments to be applied selectively instead of universally.

Flexible Line Item Decision Rules

This bidding feature of the auction system of the invention provides a method for allowing bidders to bid at the lot or line item level, while maintaining flexible decision rules on individual line items. Generally, a flexible line-item decision rule enables a buyer to automatically adjust aspects of line item level bids based upon one or more inputs at the lot or line item level.

In one embodiment, a flexible line-item decision rule is implemented by creating fixed and variable components of a bid on each of the line items that comprise a lot. Limits for individual items can be established at the initial price quote entered for that item or at a floor or ceiling below or above the initial quote. Different limits can be set for different line items and limits can be set across some or all of the items or components within a lot or market.

In this embodiment, when bids are decreased at the lot level, the amount by which they are decreased at the line item level is pro rated across the unlocked portion of the line item price bids. Pro rata adjustments will not affect the locked (or fixed) component of the line items. Thus, the locked portion remains unchanged. However, limits can be locked and unlocked dynamically during the course of an Auction by the bidder.

This particular line-item decision rule allows bidders to lock in a fixed and a variable portion of the price quote prior to the bid. Total bids for a lot can then be adjusted rapidly in response to market activity without changing individual item quotes to uneconomic levels. Further, bidders have the comfort of setting floors or ceilings on all or part of individual line item bids. During the Auction, fixed components can be re-evaluated and unlocked if necessary in response to movement in the market for the lot beyond original expectations.

In a downward auction where a total bid is decreased by more than the sum of all unlocked line item bids, the bid is rejected. Therefore, a total bid will never be less than the sum of the locked portion of the line item bids. Items can be locked or unlocked at any time during the bidding event.

An example of the Lock/Unlock feature is shown below. Initially, line item 1 is partially locked and line item 2 is entirely unlocked.

| Line Item | Locked | Unlocked | Total Price |
|---|---|---|---|
| 1 | $1.00 | $9.00 | $10.00 |
| 2 | $0.00 | $20.00 | $20.00 |
| | | | $30.00 |
| | | | Lot Price |

The bidder chooses to drop the lot price, by 10% (or $3). The $3 adjustment is then apportioned on a pro rata basis to the unlocked portions of the individual line item bids. In this case, line item #1 is reduced by $0.93 (i.e., $3×9/29), and line item #2 is reduced by $2.07 (i.e., $3×20/29). The result of these pro rata line item adjustments is reflected by the following:

| Line Item | Locked | Unlocked | Total Price |
|---|---|---|---|
| 1 | $1.00 | $8.07 | $9.07 |
| 2 | $0.00 | $17.93 | $17.93 |
| | | | $27.00 |
| | | | Lot Price |

The locked/unlocked feature is implemented in the auction system by data structures maintained in the client software that support capture of locked and unlocked unit price bids at the line item level and by providing a user interface to accept the locked/unlocked information from the bidder.

In another embodiment, a line item bid limit is used in conjunction with the line item bid amount. In this embodiment, the entire value of the line item bid may be specified as one value as opposed to two or more subcomponents (e.g. locked and unlocked). In this embodiment, the line item bid limit is specified as a distinct value against which the line item bid value is compared. In a forward auction, the line item bid limit specifies an upper limit for the line item bid value. In a reverse auction, the line item bid value must be greater than the line item bid limit.

When the bid for a lot is adjusted, the adjustment is distributed over the lot's line items. Before the adjustment is actually distributed across the line items in the lot on a pro rata basis, the inventive system ensures that the line item adjustments that would be made by a pro rata adjustment do not violate any line item bid limits set by the bidder. FIG. 4 illustrates a flowchart for determining how the line item adjustments may be calculated in this embodiment.

As shown by step 410, a bidder adjusts the bid for a lot. The bidder may manually adjust the bid amount, for example, or may use the user interface to decrease the bid by a certain percentage.

At step 415, certain variables that are used to determine and evaluate the line item adjustments are then initialized. In this embodiment, the variable “Recalculate” is a Boolean variable that is used to track whether any proposed line item adjustments violate line item bid limits. “Recalculate” is initially set to FALSE at step 415. If “Recalculate” is set to TRUE during the course of the line item adjustment determination, this will mean that certain line items need to be excluded from the pro rata adjustment calculations, and the adjustments need to be recalculated such that these variables are excluded. All variables are initially considered to be eligible for pro rata distribution adjustments.

A proposed pro rata distribution is determined for each line item at step 425. The proposed adjustment is compared to the line item bid limit, if any, at step 430. If the adjustment would make the value of the line item bid exceed the line item limit (in a forward auction), or go below the line item limit (in a reverse auction), the current line item is then ineligible for the adjustment. In this case, it is marked ineligible at step 432. If any of the line items are ineligible, the entire process needs to be repeated excluding the ineligible line items, therefore the variable Recalculate is set to TRUE at step 435. In an alternate embodiment, any lines items that are determined to be ineligible in step 432 are adjusted to the line item bid limits associated with such line items.

Even if one line item is determined to be ineligible for the adjustment distribution, the process continues to determine the eligibility of the rest of the line items. Once all of the line items have been considered, the distribution is recalculated using only the eligible line items. Therefore, after step 430, the process continues to consider the next line item at steps 440-450 whether or not the current line item is eligible. The 420-425-430-440-450 loop continues until all line items have been considered. At this point, the process continues to step 460.

If the proposed adjustments to every line item did not violate any line item bid limit rules, then Recalculate will still be FALSE, as initialized at step 415, and the proposed adjustments may then be made to the line item bid values, as shown by step 470. If, however, any proposed line item adjustment caused the value of a line item bid value to violate its line item bid limit, then the pro rata distribution needs to be recalculated using only those line items that did not violate line item bid limit rules in the first adjustment calculation. If any proposed line item adjustments violated line item bid limits, then Recalculate will have been set to TRUE at step 435, and the system will know to repeat the process at step 460.

If the adjustment process needs to be repeated, the variables are again initialized at step 415. Recalculate is again set to FALSE. However, the eligibility status of the line items is not re-initialized. If a line item was determined to be ineligible in a previous iteration, then it is ineligible for all following iterations of the line item bid adjustment process. Therefore, at step 420, only variables that are considered to be eligible are considered in the next iteration of determining proposed line item adjustments.

Since several line items may have been determined to be ineligible in the first iteration, the pro rata distribution adjustments in the next iteration may be larger. These larger adjustments may cause some line items that were previously determined to be eligible for adjustments to exceed their line item bid limits at step 430. If this is the case, these line items are then marked ineligible at step 432, and Recalculate is again set to TRUE at step 435. Once all line items have been considered, another iteration of line item adjustments will then be determined using only eligible line items.

Although not shown in FIG. 4, it is possible that the lot adjustment cannot be distributed across the line items in a way that does not violate at least one line item bid limit. In this case, an appropriate error message should be sent to the bidder. If desired, the bidder may adjust the value of one or more line item bid limits to accomplish the lot bid adjustment. Alternatively, the bidder may decide to adjust the lot bid by a smaller amount.

It should be noted that the above embodiments represent only two examples of flexible line-item decision rules that can be implemented. Generally, a line item bid can be adjusted based upon one or more changes at the lot or line item level. These flexible line-item decision rules can be created to accommodate any pre-auction bidding strategy that could be jeopardized by the bidder's interaction in a real-time auction event. For example, a customized flexible line-item decision rule can be created such that the price of a first line item maintains a specified proportion to the price of a second line item. This particular flexible line-item decision rule may be important where the bidder must ensure that one or more particular line item bids conform to internal corporate guidelines (e.g., marketing, accounting, sales, etc.).

More generally, it is contemplated by the present invention that any aspect of a line item bid (e.g., unit price, quantity, delivery time, line item characteristic, etc.) can be related to, and thereby adjusted, based upon a change in one or more aspects of the supplier's bid at either the lot or line item level. In addition, it is possible to combine different rules together to form an overall decision rule for a lot in an auction.

While the invention has been described in detail and with reference to specific embodiments thereof, it will be apparent to one skilled in the art that various changes and modifications can be made therein without departing from the spirit and scope thereof. In particular, it should be noted that while the auction functions described above have been described in the context of downward pricing auctions the auction functions can be equally applied to upward pricing auctions. Thus, it is intended that the present invention cover the modifications and variations of this invention provided they come within the scope of the appended claims and their equivalents.

What is claimed is:

1. A method to control line item price in an electronic auction, comprising:
(a) setting a minimum line item price for a line item in a lot;
(b) receiving a bid adjustment for the lot price;
(c) calculating a corresponding adjustment for the line item price using the lot bid adjustment;
(d) determining if adjusting the line item price by the amount calculated in step (c) will cause the line item price to be lower than the minimum line item price for the line item; and
(e) adjusting the line item price in accordance with said determination.

2. The method of claim 1, wherein the corresponding adjustment for the line item price is calculated on a pro rata basis.

3. The method of claim 1, wherein the corresponding adjustment for the line item price is calculated by maintaining a ratio between the line item price and the lot price.

4. The method of claim 1, wherein the corresponding adjustment for the line item price is calculated by maintaining a ratio between the line item price and the price for another line item in the lot.

5. The method of claim 1, wherein step (a) comprises setting a minimum price for every line item in a lot.

6. The method of claim 5, wherein step (c) comprises calculating corresponding adjustments for each line item price using the lot bid adjustment.

7. The method of claim 6, wherein the corresponding adjustments are calculated on a pro rata basis.

8. The method of claim 6, where in the corresponding adjustments are calculated by maintaining predetermined ratios between line item prices.

9. The method of claim 6, wherein step (d) comprises determining for each line item whether adjusting the line item price by the amount calculated in step (c) will cause the line item price to be lower than the minimum line item price for the line item.

10. The method of claim 1, wherein step (e) comprises adjusting the line item price to the minimum line item price.

11. The method of claim 1, wherein step (e) comprises adjusting the line item price to the price calculated in step (c).

12. The method of claim 1, wherein step (e) comprises making no changes to the line item price.

13. The method of claim 12, additionally comprising notifying the bidder that the lot price bid adjustment has been rejected and the lot price has not been adjusted.

14. The method of claim 1, wherein step (e) comprises using a correcting algorithm to calculate an adjusted line item price if the determination in step (d) determines that adjusting the line item price by the amount calculated in step (c) will cause the line item price to be lower than the minimum line item price for the line item.

15. The method of claim 1, wherein an auction sponsor and a plurality of bidders are coupled electronically over a communications network during the auction.

16. The method of claim 1, wherein the lot is defined at least in part by an auction sponsor.

17. A machine-readable medium whose contents cause a computer system to control line item price in an electronic auction by:
setting a minimum line item price for a line item in a lot;
receiving a bid adjustment for the lot price;
calculating a corresponding adjustment for the line item price using the lot bid adjustment;
determining if adjusting the line item price by the amount calculated in step (c) will cause the line item price to be lower than the minimum line item price for the line item; and
adjusting the line item price in accordance with said determination.

18. The machine-readable medium of claim 17, wherein the corresponding adjustment for the line item price is calculated on a pro rata basis.

19. The machine-readable medium of claim 17, wherein the corresponding adjustment for the line item price is calculated by maintaining a ratio between the line item price and the lot price.

20. The machine-readable medium of claim 17, wherein the corresponding adjustment for the line item price is calculated by maintaining a ratio between the line item price and the price for another line item in the lot.

21. The machine-readable medium of claim 17, wherein setting a minimum line item price comprises setting a minimum price for every line item in a lot.

22. The machine-readable medium of claim 21, wherein calculating a corresponding adjustment comprises calculating corresponding adjustments for each line item price using the lot bid adjustment.

23. The machine-readable medium of claim 22, wherein the corresponding adjustments are calculated on a pro rata basis.

24. The machine-readable medium of claim 22, where in the corresponding adjustments are calculated by maintaining predetermined ratios between line item prices.

25. The machine-readable medium of claim 22, wherein said determining comprises determining for each line item whether adjusting the line item price by the amount calculated will cause the line item price to be lower than the minimum line item price for the line item.

26. The machine-readable medium of claim 17 wherein said adjusting the line item price comprises adjusting the line item price to the minimum line item price.

27. The machine-readable medium of claim 17, wherein adjusting the line item price comprises adjusting the line item price to the calculated corresponding adjustment price.

28. The machine-readable medium of claim 17 wherein adjusting the line item price comprises making no changes to the line item price.

29. The machine-readable medium of claim 28, additionally comprising notifying the bidder that the lot price bid adjustment has been rejected and the lot price has not been adjusted.

30. The machine-readable medium of claim 17, wherein said adjusting the line item price comprises using a correcting algorithm to calculate an adjusted line item price if the determination determines that adjusting the line item price by the calculated amount will cause the line item price to be lower than the minimum line item price for the line item.

31. The machine-readable medium of claim 17, wherein an auction sponsor and a plurality of bidders are coupled electronically over a communications network during the auction.

32. The machine-readable medium of claim 17, wherein the lot is defined at least in part by an auction sponsor if the determination determines that adjusting the line item price by the calculated amount will cause the line item price to be lower than the minimum line item price for the line item.

33. A method to control line item price in an electronic auction, comprising:
(a) setting a maximum line item price for a line item in a lot;
(b) receiving a bid adjustment for the lot price;
(c) calculating a corresponding adjustment for the line item price using the lot bid adjustment;
(d) determining if adjusting the line item price by the amount calculated in step (c) will cause the line item price to exceed the maximum line item price for the line item; and
(e) adjusting the line item price in accordance with said determination.

34. The method of claim 33, wherein the corresponding adjustment for the line item price is calculated on a pro rata basis.

35. The method of claim 33, wherein the corresponding adjustment for the line item price is calculated by maintaining a ratio between the line item price and the lot price.

36. The method of claim 33, wherein the corresponding adjustment for the line item price is calculated by maintaining a ratio between the line item price and the price for another line item in the lot.

37. The method of claim 33, wherein step (a) comprises setting a maximum price for every line item in a lot.

38. The method of claim 37, wherein step (c) comprises calculating corresponding adjustments for each line item price using the lot bid adjustment.

39. The method of claim 38, wherein the corresponding adjustments are calculated on a pro rata basis.

40. The method of claim 38, where in the corresponding adjustments are calculated by maintaining predetermined ratios between line item prices.

41. The method of claim 40, wherein step (d) comprises determining for each line item whether adjusting the line item price by the amount calculated in step (c) will cause the line item price to exceed the maximum line item price for the line item.

42. The method of claim 33, wherein step (e) comprises adjusting the line item price to the maximum line item price.

43. The method of claim 33, wherein step (e) comprises adjusting the line item price to the price calculated in step (c).

44. The method of claim 33, wherein step (e) comprises making no changes to the line item price.

45. The method of claim 44, additionally comprising notifying the bidder that the lot price bid adjustment has been rejected and the lot price has not been adjusted.

46. The method of claim 33, wherein step (e) comprises using a correcting algorithm to calculate an adjusted line item price if the determination in step (d) determines that adjusting the line item price by the amount calculated in step (c) will cause the line item price to exceed the maximum line item price for the line item.

47. The method of claim 33, wherein an auction sponsor and a plurality of bidders are coupled electronically over a communications network during the auction.

48. The method of claim 33, wherein the lot is defined at least in part by an auction sponsor.

49. A machine-readable medium whose contents cause a computer system to control line item price in an electronic auction by:
setting a maximum line item price for a line item in a lot;
receiving a bid adjustment for the lot price;
calculating a corresponding adjustment for the line item price using the lot bid adjustment;
determining if adjusting the line item price by the amount calculated in step (c) will cause the line item price to exceed the maximum line item price for the line item; and
adjusting the line item price in accordance with said determination.

50. The machine-readable medium of claim 49, wherein the corresponding adjustment for the line item price is calculated on a pro rata basis.

51. The machine-readable medium of claim 49, wherein the corresponding adjustment for the line item price is calculated by maintaining a ratio between the line item price and the lot price.

52. The machine-readable medium of claim 49, wherein the corresponding adjustment for the line item price is calculated by maintaining a ratio between the line item price and the price for another line item in the lot.

53. The machine-readable medium of claim 49, wherein setting a maximum line item price comprises setting a maximum price for every line item in a lot.

54. The machine-readable medium of claim 53, wherein calculating a corresponding adjustment comprises calculating corresponding adjustments for each line item price using the lot bid adjustment.

55. The machine-readable medium of claim 49, wherein the corresponding adjustments are calculated on a pro rata basis.

56. The machine-readable medium of claim 54, where in the corresponding adjustments are calculated by maintaining predetermined ratios between line item prices.

57. The machine-readable medium of claim 54, wherein said determining comprises determining for each line item whether adjusting the line item price by the amount calculated will cause the line item price to exceed the maximum line item price for the line item.

58. The machine-readable medium of claim 49, wherein said adjusting the line item price comprises adjusting the line item price to the maximum line item price.

59. The machine-readable medium of claim 49, wherein said adjusting the line item price comprises adjusting the line item price to the calculated corresponding adjusted price.

60. The machine-readable medium of claim 49, wherein adjusting the line item price comprises making no changes the line item bid price.

61. The machine-readable medium of claim 60, additionally comprising notifying the bidder that the lot price bid adjustment has been rejected and the lot price has not been adjusted.

62. The machine-readable medium of claim 49, wherein said adjusting the line item price comprises using a correcting algorithm to calculate an adjusted line item price if the determination determines that adjusting the line item price by the calculated amount will cause the line item price to exceed the maximum line item price for the line item.

63. The machine-readable medium of claim 49, wherein an auction sponsor and a plurality of bidders are coupled electronically over a communications network during the auction.

64. The machine-readable medium of claim 49, wherein the lot is defined at least in part by an auction sponsor.

65. A method of controlling line item price in an electronic auction between a sponsor of the auction and a plurality of bidders, wherein the auction has a plurality of lots for auctioning, comprising:
defining a lot having a first line item, a second line item and a lot price, with each line item having a line item price and a minimum line item price;
receiving a request to modify said lot price; and
modifying each line item price in accordance with said request, such that no line item's price is adjusted below its minimum line item price.

66. The method of claim 65, wherein the line item prices are modified on a pro rata basis.

67. The method of claim 65, wherein the line item prices are modified such that a predetermined ratio between line item prices is maintained.

68. A machine-readable medium having instructions stored thereon which when executed by a processor, cause the processor to:
define a lot in an electronic auction to have a first line item, a second line item and a lot price, with each line item having a line item price and a minimum line item price;
receive a request to modify said lot price; and
modify each line item price in accordance with said request, such that no line item's price is adjusted below its minimum line item price.

69. The machine-readable medium of claim 68, wherein the line item prices are modified on a pro rata basis.

70. The machine-readable medium of claim 68, wherein the line item prices are modified such that a predetermined ratio between line item prices is maintained.

71. A method to control line item aspects in an electronic auction, comprising:
(a) defining a line item decision rule, said line item decision rule being created to accommodate a pre-auction bidding strategy relating to one or more aspects of a line item portion of a bid for a lot;
(b) receiving information specifying a bid for a lot of products, said bid including a plurality of line item portions for corresponding line items in said lot;
(c) receiving information specifying an adjustment to one or more aspects of said bid for said lot;
(d) analyzing said adjustment to said one or more aspects of said bid for said lot based on said flexible line item decision rule to determine a corresponding adjustment to one or more aspects of one or more line item portions of said bid; and
(e) effecting said corresponding adjustment to said one ore more aspects of said one ore more line item portions of said bid based upon the analysis of step (d).

72. The method of claim 71, wherein said line item decision rule comprises setting a minimum price for a line item.

73. The method of claim 71, wherein said line item decision rule comprises setting a maximum price for a line item.

74. The method of claim 71, wherein said line item decision rule comprises defining a ratio for a line item, such that adjusting the lot price will automatically adjust the line item price in a manner that maintains the ratio.

75. A computer-readable medium for controlling line item aspects in an electronic auction, the medium containing instructions which, when executed by a processor, will cause the processor to:
(a) define a line item decision rule, said line item decision rule being created to accommodate a pre-auction bidding strategy relating to one or more aspects of a line item portion of a bid for a lot;
(b) receive information specifying a bid for a lot of products, said bid including a plurality of line item portions for corresponding line items in said lot;
(c) receive information specifying an adjustment to one or more aspects of said bid for said lot;
(d) analyze said adjustment to said one or more aspects of said bid for said lot based on said flexible line item decision rule to determine a corresponding adjustment to one or more aspects of one or more line item portions of said bid; and
(e) effect said corresponding adjustment to said one ore more aspects of said one or more line item portions of said bid based upon the analysis of (d).

76. The computer-readable medium of claim 75, wherein said line item decision rule comprises setting a minimum price for a line item.

77. The computer-readable medium of claim 75, wherein said line item decision rule comprises setting a maximum price for a line item.

78. The computer-readable medium of claim 75, wherein said line item decision rule comprises defining a ratio for a line item, such that adjusting the lot price will automatically adjust the line item price in a manner that maintains the ratio.

79. A method of controlling line item price in an electronic auction, comprising:
(a) displaying a current bid for a lot to a bidder;
(b) receiving a request for a bid adjustment to the lot from the bidder, wherein the request is to decrease the bid;
(c) displaying an updated bid for the lot, wherein the updated bid is not equivalent to the current bid decreased by the amount of the bid adjustment request received in step (b), but is determined by summing the minimum line item prices for each line item in the lot.

80. A method of controlling line item price in an electronic auction, comprising:
(a) displaying a current bid for a lot to a bidder;
(b) receiving a request for a bid adjustment to the lot from the bidder, wherein the request is to increase the bid;
(c) displaying an updated bid for the lot, wherein the updated bid is not equivalent to the current bid increased by the amount of the bid adjustment request received in step (b), but is determined by summing the maximum line item prices for each line item in the lot.

81. A method of controlling line item price in an electronic auction, comprising:
(a) displaying a current bid for a lot to a bidder;
(b) receiving a request for a bid adjustment to the lot from the bidder, wherein the request is to decrease the bid;
(c) displaying an updated bid for the lot, wherein the updated bid is not equivalent to the current bid decreased by the amount of the bid adjustment request received in step (b), but is determined by summing locked portions of line item prices for each line item in the lot.

82. A method of controlling line item price in an electronic auction, comprising:
(a) displaying a current bid for a lot to a bidder;
(b) receiving a request for a bid adjustment to the lot from the bidder, wherein the request is to increase the bid;
(c) displaying an updated bid for the lot, wherein the updated bid is not equivalent to the current bid increased by the amount of the bid adjustment request received in step (b), but is determined by summing locked portions of line item prices for each line item in the lot.

83. A bidding device operated by a bidder during an auction, said bidding device comprising software that enables the bidder to submit bids to an online auction;
wherein said bidding device displays information about a lot, said information including a bid price for a lot, a bid price for each line item in the lot, and a minimum bid price for at least one line item in the lot;
wherein if said bidder changes said lot bid price, each line item bid price is updated to reflect a proportional change in value, such that no updated line item bid price is adjusted to a value less than its corresponding minimum bid price.
